(19) United States
(12) Patent Application Publication
(10) Pub. No.: US 2008/0017643 A1
(43) Pub. Date: Jan. 24, 2008

(54) Ventilation Device, Particularly for Fluid-Storing Reservoirs Such as Tanks

(76) Inventor: Silke Kuhnrich, Volklingen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/794,499

(22) PCT Filed: Jan. 26, 2006
(86) PCT No.: PCT/EP06/00652

§ 371 Date: Jun. 29, 2007

(30) Foreign Application Priority Data
Mar. 24, 2005 (DE) 10 2005 013 659.1

(51) Int. Cl. B60K 15/035; B65D 51/16; B65D 90/34

(52) U.S. Cl. 220/303; 220/361

(57) ABSTRACT

The invention relates to a ventilation device, particularly for fluid-storing reservoirs such as tanks, comprising a connecting part (1), which can be attached to the opening of the reservoir and which serves to form an air- and/or fluid-conducting connection between the inside of the reservoir and the surroundings. This connection is effectively sealed off by means of a labyrinth-like seal consisting of a system of seal passages (53, 59, 69, 73) at least from the penetration of media such as water and/or cleaning chemicals but is not sealed off from an exchange of air for the actual ventilation. In addition, a filter element (61) is placed inside the connection. At least a portion of the seal passages (59, 69, 73) are formed on a ventilation chamber (41), which can be releasably attached to the connecting part (1) and which has a seat (79) for the filter element provided in the form of a filter leaf (61), in which the filter leaf (61) is held in such a manner that it forms, with at least a portion of both of its broadsides, a partition between two successive seal passages (59 and 69) adjacently extending in principal directions that are at least approximately parallel to one another.

The invention relates to a ventilation device, particularly for fluid-storing reservoirs such as tanks, comprising a connecting part which can be attached to an opening of the reservoir for forming an air- and fluid-conducting connection between the interior of the reservoir and the exterior, this connection being effectively sealed by means of a labyrinth-like seal of a system of seal passages at least against passage of penetrating media such as water or cleaning chemicals, but not against air exchange for actual ventilation, and within the connection there being a filter element.

Ventilation devices of this type are known, cf. WO 2004/035343 A1. These tank ventilation devices prevent penetrating contaminating media from the environment from being able to penetrate into the hydraulic system beginning with the tank, but prevent the required air exchange from being able to take place. Poorly designed reservoir ventilation could cause additional loading of the hydraulic system and thus for example could lead to shortened service lives of the system filters located in the hydraulic system. In particular the tank ventilation devices with their filters should efficiently precipitate solid particles from the air which may subsequently flow into the tank.

It is recognized that tank and/or engine contaminants which arise in practical use are usually eliminated by cleaning measures by means of steam jet devices under high pressure, with the consequence that penetrating media such as water and/or cleaning chemicals can enter the interior of the ventilation device and accordingly the interior of the tank; this is extremely disadvantageous for the quality of the stored fluid in the tank, especially when dirt particles are flushed in at the same time by way of the fluid.

With respect to these circumstances, the object of the invention is to devise a ventilation device which is improved such that in spite of a simple construction which is economical to produce, it ensures reliable sealing against penetrating media of any type, without however preventing the required air exchange.

According to the invention, this object is achieved by a ventilation device which has the features of claim 1 in its entirety.

In that, as specified in the characterizing part of claim 1, there are seal passages of the labyrinth-like seal system in a ventilation chamber which is separate from the connecting part of the device, which chamber moreover also forms the seat for a filter element which is integrated into the ventilation device, production of the device is greatly simplified because the actual operating elements need not all be installed in the connecting part, but are provided in a separate chamber which is made as a component which is used specially for ventilation and sealing. The connecting part can therefore be made as a comparatively simple component which is oriented to its actual function as a sealable entry part of the tank opening with one or more fluid connecting sleeves. At the same time it becomes possible to make a plurality of seal passages which form a labyrinth-like system in a structurally simple manner on the separate component of the ventilation chamber, including the filter leaf which according to the invention is installed such that it acts as a partition between two seal passages which lie next to one another; this contributes to further simplification of the design.

Advantageously the seat provided in the ventilation chamber for the filter leaf can be made such that it borders the filter leaf on more or less its entire periphery, fixing it on the edge side. Because the filter leaf forms such a fixed component of the ventilation chamber, installation of the device is simplified, because only a single component need be attached to the connecting part in assembly.

In the embodiments in which the connecting part for its attachment to the reservoir, that is, especially to a tank opening, has a fastening flange with a sealing surface for a sealing element which seals the peripheral region of the flange relative to the edge of the opening of the reservoir, the arrangement can be made such that the flange at a distance from its peripheral region has at least one inner connecting passage which bypasses the sealing element and which leads from the interior of the reservoir to a first seal passage of the labyrinth-like system.

In this embodiment the first seal passage which is connected to the connecting passage is made preferably on the connecting part and extends to the seal plane of the flange perpendicular along an attachment plane which is provided laterally on the connecting part and to which the ventilation chamber can be attached, preferably by screwing together.

The ventilation chamber can be a housing which is open on one side, of more or less rectangular shape, with its open side with an intermediate layer of a seal which can be attached to the attachment plane of the connecting part.

Because according to the invention important elements of the ventilation device are formed by a ventilation chamber which can be attached to the connecting part, a labyrinth-like seal system with four seal passages next to one another can be implemented in a simple design, so that especially high safety against passage of foreign media is ensured.

In one especially advantageous embodiment, the attachment plane for the ventilation chamber is provided on a shoulder which projects to the outside and which extends radially to the outside from the main body of the connecting part, i.e., a central, hollow cylindrical sleeve part of the connecting part, so that the attachment plane for the part of the outside wall of the connecting part which forms the ventilation chamber is offset to the outside relative to the sleeve part, this wall part which forms the attachment plane having a flat inner surface which runs at a distance from the facing outer surface of the sleeve part, so that in between an intermediate space is formed which forms the first seal passage and which is closed on the end away from the flange and open on the end adjacent to the flange, and is connected to a connecting passage in the flange.

The invention will be explained below in particular using one embodiment shown in the drawings.

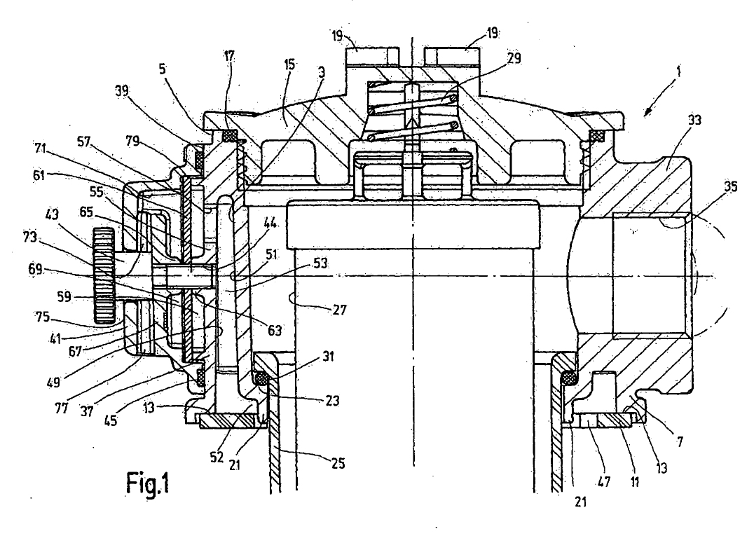

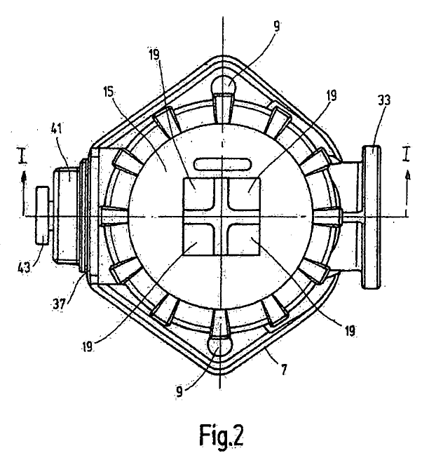

FIG. 1 shows a section of one embodiment of the ventilation device according to the invention, corresponding to the cutting plane referred to as I-I in FIG. 2, and

FIG. 2 shows a top view of the embodiment drawn on a smaller scale than in FIG. 1.

In the drawings reference number 1 refers to a connecting part as a whole which is a metallic diecasting which has a central sleeve part in the form of a round hollow body 3 which extends from the upper, open end 5 to a lower attachment flange 7. The flange 7 on the opening of a tank which is not shown in the drawings can be screwed to the tank wall by screwing together by means of the screw holes 9 which are visible only in FIG. 2, the edge of the opening relative to the flange 7 being sealed by means of a sealing element 11 which extends along the sealing surface 13 on the peripheral region of the flange 7. The upper end 5 of the connecting part 1 which faces away from the flange 7 can be sealed tight by means of a screw cover 15 and a cover seal 17. In the central region of the top of the screw cover 15 there are four projecting elevations 19 which form action surfaces for a rotary handle in the configuration and design which is conventional for these covers.

In the embodiment shown here, the sleeve part 3 of the connecting part 1 in the vicinity of the lower end region 21 of the sleeve part 3 on its inside wall forms an annular shoulder 23 which projects radially to the inside as a seat for a tank top filter 25 which is placed against the annular shoulder 23 by means of a compression spring 29 clamped between the screw cover 15 and the filter body 27 by way of an O-ring 31 which is inserted in between. As a supply for the fluid to the interior of the sleeve part 3 and thus to the outside of the filter body 27, the connecting part 1 has a lateral connecting sleeve 33 with an inside thread 35.

On the side diametrically opposite the connecting sleeve 33 the connecting part 1 has a shoulder 37 which projects radially to the outside away from the sleeve part 3 and which on its outer surface defines an attachment plane 39 which forms a contact surface for attaching a ventilation chamber 41. The ventilation chamber 41 can be fixed on the attachment plane 39 by means of a locking screw 43 which is screwed into a threaded hole 44 in the shoulder 37, the seal 45 being intended for sealing relative to the contact surface with the attachment plane 39.

As FIG. 1 shows, between the inner longitudinal edge of the sealing element 11 and the end region 21 of the sleeve part 3, there remains an entry point 47 for the connection between the interior of the reservoir or tank and the ventilation device. This connection is formed by a connecting passage 52 which extends inside the flange 7 along the outer periphery of the end part 21 of the sleeve part 3. As already mentioned, the ventilation chamber 41 of the ventilation device is attached to a shoulder 37 which is offset to the outside from the sleeve part 3. The inner surface 49 of the wall part which is shifted to the outside and which forms the attachment plane 39 is thus located at a distance from the outer surface 51 of the sleeve part 3, so that a first seal passage 53 is formed between them and is connected to the connecting passage 52 and thus is connected to the interior of the reservoir or tank, bypassing the sealing element 11, see entry point 47.

The wall part 55 with an inside surface 49 bordering the first seal passage 53, in its upper region away from the flange 7, has an outlet 57 which leads to a second seal passage 59 which, in the same manner as the first seal passage 53, extends essentially perpendicular to the seal plane of the flange 7 and essentially parallel to the first seal passage 53 next to it. This second seal passage 59, which is bordered on the one hand by the wall part 55, on the other hand borders the filter leaf 61 which is rectangular in outline and which adjoins a projection 63 which surrounds the threaded hole 44 in the wall part 55 with its one wide side, while the other wide side of the filter leaf 61 adjoins a projection 65 on the inside wall 67 of the ventilation chamber 41 which runs at a distance from the filter leaf 61 parallel to it. The filter leaf 61 held in this way at a distance both from the wall part 55 and also the inside wall 67 together with the inside wall 67 forms a third seal passage 69 which in turn runs parallel to the second seal passage 63, the connection between the latter seal passages being dictated by the fluid connecting passage which takes place through the filter leaf 61.

In turn, in the upper region the inside wall 67 forms an outlet 71 to an intermediate space between the outside of the inside wall 67 and the inside of the outside wall 73 of the ventilation chamber 41, by which a fourth seal passage 73 is formed, with a similar positional orientation to the seal passages which lie next to it, the fourth seal passage 73 having a lower end 77 which is open to the exterior.

When the ventilation chamber 41 has been screwed on the attachment plane 39, the filter leaf 61 in its approximately central region is held on the wall part 55 by contact with the projection 63. When the ventilation chamber 41 has been removed from the connecting part 1, the filter leaf 61 is fixed on the ventilation chamber 41. For this purpose the seat 79 which is provided in the region of the open end of the ventilation chamber 41 for the filter leaf 61 is made such that it borders the filter leaf 61 over essentially its entire peripheral region with a fit such that the seat 79 for the filter leaf 61 acts to fix it. For the mounting process thus the filter leaf 61 together with the ventilation chamber 41 forms a uniform component which can be attached to the wall part 55 which defines the attachment plane 39 by screwing together by means of the locking screw 43. In this case the locking screw 43 extends through the through holes located approximately in the central region of the ventilation chamber 41 in the outside wall 75 and the inside wall 67 into the threaded hole 44. As a comparison of FIGS. 1 and 2 shows, the ventilation chamber 41 in outline is largely rectangular, in accordance with the rectangular outline of the filter leaf 61 held in it. Like the connecting part 1, the ventilation chamber 41 is made as a metallic diecasting. As FIG. 1 shows, in this respect the walls which border the first seal passage 53 and the fourth seal passage 73 are quite slightly diverging to promote shaping processes. As FIG. 1 likewise shows, in correspondence thereto the sleeve part 3 on its inside surface is shaped accordingly so that the inside width of the inner cavity of the sleeve part 3, proceeding from the upper end 5 which is adjacent to the sealing cover 15, as far as the annular shoulder 23, is reduced to a small extent.

1. Ventilation device, particularly for fluid-storing reservoirs such as tanks, comprising a connecting part which can be attached to an opening of the reservoir for forming and air- and fluid-conducting connection between the interior of the reservoir and the environment, this connection being effectively sealed by means of a labyrinth-like seal of a system of seal passages (53, 59, 69, 73) at least against passage of penetrating media such as water or cleaning chemicals, but not against air exchange for actual ventilation, and within the connection there being a filter element (61), characterized in that at least some of the seal passages are made on the ventilation chamber (41) which can be detachably fastened to the connecting part (1) and wherein it has a seat (79) for the filter element which is made as a filter leaf (61) and in which the filter leaf is held such that with at least part of its two wide sides it forms a partition between two succeeding seal passages (59, 69) which extend next to one another in the main directions which are at least approximately parallel to one another.

2. The ventilation device according to claim 1, wherein the seat (79) in the ventilation chamber (41) borders the filter leaf (61) on more or less its entire periphery, fixing it on the edge side.

3. The ventilation device according to claim 1, wherein the connecting part (1) for its attachment to the reservoir has a fastening flange (7) with a sealing surface (13) for a sealing element (11) which seals the peripheral region of the flange (7) relative to the edge of the opening of the reservoir, and wherein the flange (7) at a distance from its peripheral region has at least one connecting passage (52) which leads from the interior of the reservoir to a first seal passage (53) of the labyrinth-like system, by-passing the sealing element (11).

4. The ventilation device according to claim 3, wherein the first seal passage (52) is made on the connecting part (1) and extends in the direction perpendicular to the seal plane of the flange (7) along an attachment plane (39) which is provided laterally on the connecting part (1) and to which the ventilation chamber (41) can be attached.

5. The ventilation device according to claim 4, wherein the ventilation chamber (41) can be attached to the attachment plane (39) of the connecting part (1) by screwing together.

6. The ventilation device according to claim 5, wherein the ventilation chamber (41) is a housing which is open on one side, of largely rectangular shape, with its open side with an intermediate layer of a seal (45) which can be attached to the attachment plane (39) of the connecting part (1).

7. The ventilation device according to claim 6, wherein the first wide side of the filter leaf (61) and the part (55) of the outside wall of the connecting part (1) which forms the attachment plane (39) of the ventilation chamber (41) border a second seal passage (59) located between them and wherein the outside wall of the connecting part (1) which separates the first seal passage (53) from the second seal passage (59) has at least one outlet (57).

8. The ventilation device according to claim 7, wherein the second wide side of the filter leaf (61) and the inner intermediate wall (67) of the ventilation chamber (41) which runs parallel at a distance to the second wide side border a third seal passage (69) between themselves and wherein the intermediate wall (67) has an outlet (71).

9. The ventilation device according to claim 8, wherein the intermediate wall (67) and the outside wall (75) of the ventilation chamber (41) located at a distance from the intermediate wall border a fourth seal passage (73) between themselves which is open on its end (77) facing the flange (7) of the connecting part (1) and is connected to the third seal passage (69) via the outlet (71) in the intermediate wall (67).

10. The ventilation device according to claim 9, wherein there are outlets (57, 71) between two succeeding seal passages in their region away from the flange (7) of the connecting part (1).

11. The ventilation device according to claims 3, wherein the connecting part (1) has a central, round sleeve part (3) which has one end (7) which is at a distance to the flange (7) and which can be sealed by a sealing cover (15), and in the region nearer the flange (7) on the inside wall has an annular shoulder (23) which projects radially to the inside for forming a seat for a tank top filter (25) which can be held in the reservoir.

12. The ventilation device according to claim 11, wherein there is a part (55) of the outside wall of the connecting part (1) which forms the attachment plane (39) of the ventilation chamber (41) on the shoulder (37) which projects away from the sleeve part (3) radially to the outside, the wall part (55) which forms the attachment plane (39) having a flat inner surface (49) which runs at a distance from the facing outer surface (51) of the sleeve part (3) so that in between an intermediate space is formed which forms the first seal passage (53) and which is closed on the end away from the flange (7) and open on the end adjacent to the flange (7) and is connected to a connecting passage (57) which bypasses the sealing element (11).
